(19) United States
(12) Patent Application Publication
(10) Pub. No.: US 2008/0154786 A1
(43) Pub. Date: Jun. 26, 2008

(54) Single party platform for sale and settlement of OTC derivatives

(75) Inventor: David Friedberg, San Francisco, CA (US)

Correspondence Address: CARR & FERRELL LLP, 2200 GENG ROAD, PALO ALTO, CA, 94303, US

(73) Assignee: WeatherBill, Inc.

(21) Appl. No.: 11/645,951

(22) Filed: Dec. 26, 2006

(51) Int. Cl. G06Q 40/00

(52) U.S. Cl. 705/36 R; 705/37

(57) ABSTRACT

Exemplary systems and methods for selling and settling an over-the-counter (OTC) derivative on a single party platform is provided. In exemplary embodiments, terms for the OTC derivative are received from a purchaser by a derivative seller system. Based on the terms, a pricing analysis is performed in an automated manner in order to provide a price for the OTC derivative. Should the purchaser decide to purchase the OTC derivative, payment information is received and processed by the same derivative seller system. Upon occurrence of a payout trigger, the OTC derivative is settled and payment is made to the purchaser, in an automated manner.

### CROSS-REFERENCE TO RELATED APPLICATIONS

The present application is related to U.S. patent application Ser. No. ______ filed Dec. 1, 2006 entitled “Systems and Methods for Automated Weather risk Assessment,” and U.S. patent application Ser. No. ______ filed Dec. 1, 2006 entitled “System and Method for Creating Customized Derivatives,” both of which are herein incorporated by reference.

### BACKGROUND OF THE INVENTION

1. Field of the Invention

Embodiments of the present invention relate generally to sales of derivatives, and more particularly the sale of over-the-counter derivates via a single party platform.

2. Description of Related Art

Generally, derivatives are conditional instructions used by market participants to purchase or manage an asset. One use of derivatives is to remove risk from a situation. One form of derivatives are weather derivatives. Because weather can negatively impact revenue for a business, weather derivatives may be used to reduce the impact that adverse weather may create. Alternately, weather derivatives can be used in speculation.

Weather derivatives transactions are presently monitored and regulated by the Commodity Futures Trading Commission. As such, the regulation of these financial instruments falls under the Commodity Exchange Act. Currently, weather derivatives may be transacted party-to-party, without clearing through a regulated marketplace, exchange, or derivatives transaction execution facility (over-the-counter, or “OTC”), provided both parties are eligible, as outlined in the Commodity Exchange Act.

Conventionally, OTC derivatives are available for purchase via a three party system. Typically, a potential purchaser will contact a third party facilitator or broker to find one or more sellers of the OTC derivative. The third party facilitator will exchange information and negotiate terms between the potential purchaser and one or more sellers to determine a sales price for the OTC derivative.

In some of these prior art systems, communications between the potential purchaser and the sellers are implemented on a platform similar to instant messaging. For example, an energy company may be in real time communication with a third party facilitator (e.g., Goldman Sacks) and an insurance company providing the derivatives for sale. While information and terms may be exchanged between the three parties in this communication system, the actual execution of the trade (i.e., purchase of the OTC derivative) may only be performed, for example, via phone calls and the exchange of actual trade documents or via some human-intervened process defined in a prior trade agreement between the two trading parties.

As illustrated by the example above, prior art systems used for OTC derivative trading suffer a disadvantage in that trading is typically handled manually. In addition to the back-and-forth exchange of information and trade documents, instantaneous determination of a price for the OTC derivative in an automated manner is not feasible. In particular with OTC derivatives, there is no central exchange to collate and disseminate prices.

A further disadvantage to the three party system for OTC derivative purchase is that a commission will need to be paid to the facilitator or broker for their services. This in turn increases the cost to the purchaser.

### SUMMARY OF THE INVENTION

Embodiments of the present invention provide a system and method for sale of over-the-counter (OTC) derivatives via a single party platform over a network. In exemplary embodiments, the single party platform allows a single party (i.e., the derivative seller) to price and sell the OTC derivative to any eligible purchaser. The network may comprise the Internet, in accordance with some embodiments.

In various embodiments, terms for the OTC derivative are received from a purchaser by a derivative seller system. The terms may comprise, for example, a definition of at least one measurement of an underlying asset, mechanisms for triggering a payoff based on the underlying asset, amount of payoff, and limitations on payoffs.

Based on the terms provided by the purchaser, a pricing analysis is performed in an automated manner in order to provide a price for the OTC derivative. In some embodiments, the purchaser is allowed to change one or more terms and perform subsequent pricing analysis.

Should the purchaser decide to purchase the OTC derivative, trade and sale confirmations, and payment information is processed by the same derivative seller system. In exemplary embodiments, eligibility of the purchaser to trade the OTC derivative is verified. Additionally, an agreement based on the ISDA Master Agreement is referenced or required to be digitally signed in order to proceed with the purchase. Purchaser payment information is obtained or accessed from the purchaser's account, and the purchase is completed.

### BRIEF DESCRIPTION OF THE DRAWINGS

FIG. 1 is a block diagram of an exemplary environment in which embodiments of the present inventions may be practiced.

FIG. 2 is a block diagram of an exemplary derivative seller system.

FIG. 3 is a block diagram of an exemplary risk assessment engine.

FIG. 4 is a block diagram of an exemplary purchase engine of the derivative seller system.

FIG. 5 is a flowchart of an exemplary method for transacting a sale and settlement of the OTC derivative.

FIG. 6 is a flowchart of an exemplary method for obtaining derivative terms.

FIG. 7 is a flowchart of an exemplary method for transacting a purchase of the OTC derivative.

### DESCRIPTION OF EXEMPLARY EMBODIMENTS

Embodiments of the present invention provide a system and method for purchase of over-the-counter (OTC) derivatives via a single party platform. In exemplary embodiments, the single party platform allows a single party to price and sell the OTC derivative to any eligible purchaser that is open to single source pricing without negotiation. As such, there is no facilitator or broker involved in the transaction.

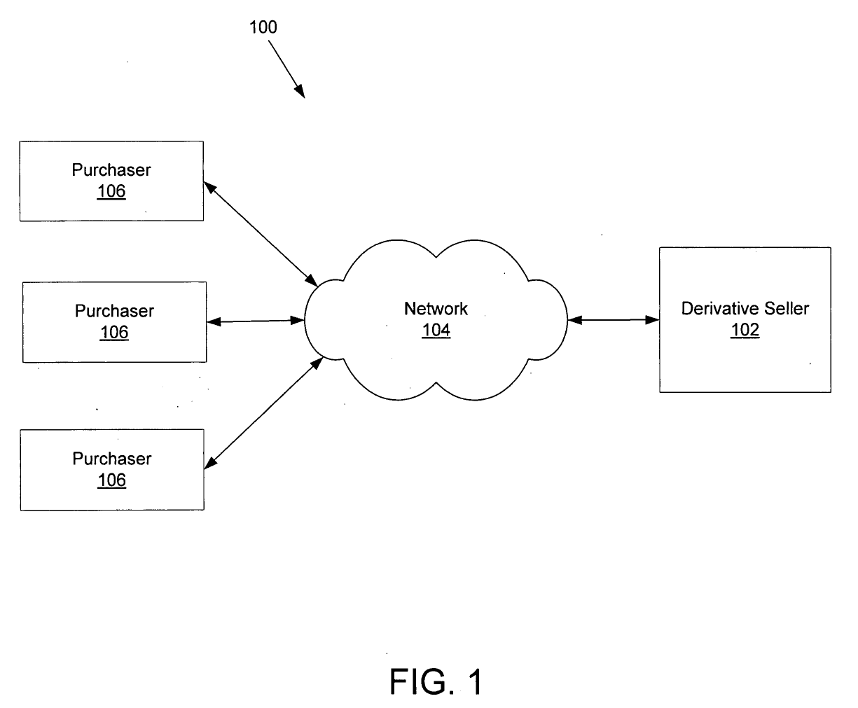

Referring to FIG. 1, an exemplary environment 100 in which embodiments of the present invention may be practiced is shown. The environment 100 comprises a derivative seller 102 coupled via a network 104 to a plurality of derivative purchasers 106. In exemplary embodiments, the network 104 may comprise the Internet. In other embodiments, the network 104 may comprise a local area network, a wide area network, a peer-to-peer network, the Public Switched Telephone Network, or any other network that facilitates communications between the derivative seller 102 and the purchaser(s) 106. In some embodiments, more than one network 104 and/or more than one type of network 104 may be utilized to allow the parties in the environment 100 to communicate with each other.

The derivative seller 102 provides a single party platform for the sale of the OTC derivatives. That is, the derivative seller 102 performs the functions of both a prior art facilitator/broker and a prior art seller of the OTC derivatives. In exemplary embodiments, the purchaser 106 will directly access the derivative seller 102 via the network 104 to request a quote for an OTC derivative. Should the purchaser 106 decide to purchase the OTC derivative, the transaction may be completed with the derivative seller 102 via the same or alternative network 104.

For example, a purchaser 106 may access a website of the derivative seller 102. Via the website and the network 104 (i.e., the Internet), the purchaser 106 provides desired terms for the OTC derivative. The terms are received by a coupled system, which will determine a price for the OTC derivative in an automated manner. The price is provided to the purchaser 106 for review. In some embodiments, the purchaser 106 may adjust terms in order to obtain different price quotes. Should the purchaser 106 decide to buy the OTC derivative, the transaction may be completed online via an exchange of digital agreements and digital signatures.

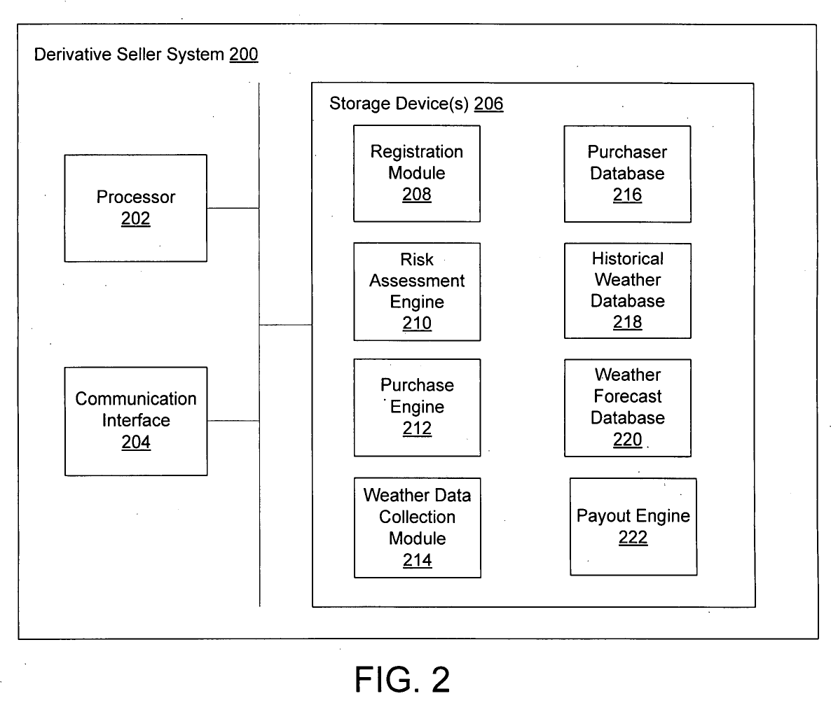

In an alternative example, the purchaser 106 may access the derivative seller 102 by phone via a PSTN. The terms are orally provided to an agent of the derivative seller 102 who inputs the terms into a coupled system (e.g., a derivative seller system further discussed in FIG. 2) in order to obtain a price quote. Should the purchaser 106 decide to buy the OTC derivative, documents may be mailed, faxed, or e-mailed between the derivative seller 102 and the purchaser 106. Any mechanism may be utilized to facilitate the communication between the purchaser 106 and the derivative seller 102 and to transact the sale of the OTC derivative without the use of a facilitator, broker, or exchange.

In one embodiment, the OTC derivative is a weather derivative. A weather derivative is a derivative whose payout is based on a specified weather index (e.g., the buyer receives a payout for each day of snow in a particular location during a term of the derivative). Through the purchase of a weather derivative, a business may seek to cover a negative impact of weather on its financials. For simplicity of discussion, the following description will be presented with reference to the purchase of weather derivatives over an online network 104 (e.g., the Internet). However, it is understood that embodiments of the present invention may be applied to any type of OTC derivatives and any type of network 104.

It should be noted that FIG. 1 is exemplary. Alternative embodiments may contemplate modifications to the environment 100 but still be within the scope of present embodiments. For example, any number of purchasers 106 may be present in the environment 100. The purchaser 106 may comprise any individual or business entity which seeks to purchase a derivative that reduces risk for some aspect of their business.

Referring now to FIG. 2, a derivative seller system 200 is shown. The derivative seller system 200 comprises a processor 202, a communication interface 204, and at least one storage device 206. The communication interface 204 is configured to facilitate communications between the derivative seller system 200 and the purchasers 106. The storage devices 206 may comprise any type of device or memory that stores data. In exemplary embodiments, the storage device 206 comprises a registration module 208, a risk assessment engine 210, a purchase engine 212, a weather data collection module 214, a plurality of databases, and a payout engine 222. The databases may comprise a purchaser database 216, a historical weather database 218, and a weather forecast database 220.

The registration module 208 is configured to create and maintain an account with the derivative seller site (e.g., a website on an Internet) for the purchaser 106. Upon initial access or purchase of an OTC derivative, the purchaser 106 will be requested to set up an account. The registration module 208 will collect data from the purchaser including name, address or location, and contact information (e.g., phone number, fax number, e-mail address, etc.). In some embodiments, the purchaser 106 may be allowed to input and store payment information, such as bank account routing information or credit card information. In exemplary embodiments, the information received from the purchaser 106 is stored in the purchaser database 216.

An upfront agreement may be presented to the purchaser 106 via the registration module 208, in some embodiments, which require the purchaser 106 to attest to their eligibility or intent to purchase OTC derivatives. In one example, in order to be eligible to purchase OTC derivatives, a business may be required to have a minimum net worth. By agreeing to the upfront agreement, the purchaser 106 may attest to eligibility to purchase the OTC derivative. The purchaser 106 will, in some embodiments, be required to provide a digital signature on the agreement. Additionally, during the account set-up or prior to any OTC derivative transactions, the purchaser 106 may be required to provide paper evidence to the derivative seller 102 demonstrating eligibility to purchase OTC derivatives.

In some embodiments, an International Swaps and Derivatives Association (ISDA) Master Agreement may also be provided during the account set-up process. An acknowledgement of the receipt and review of the ISDA Master Agreement may be required. For example, a digital or real signature may be required on the ISDA Master Agreement before the purchaser 106 is allowed to purchase OTC derivatives.

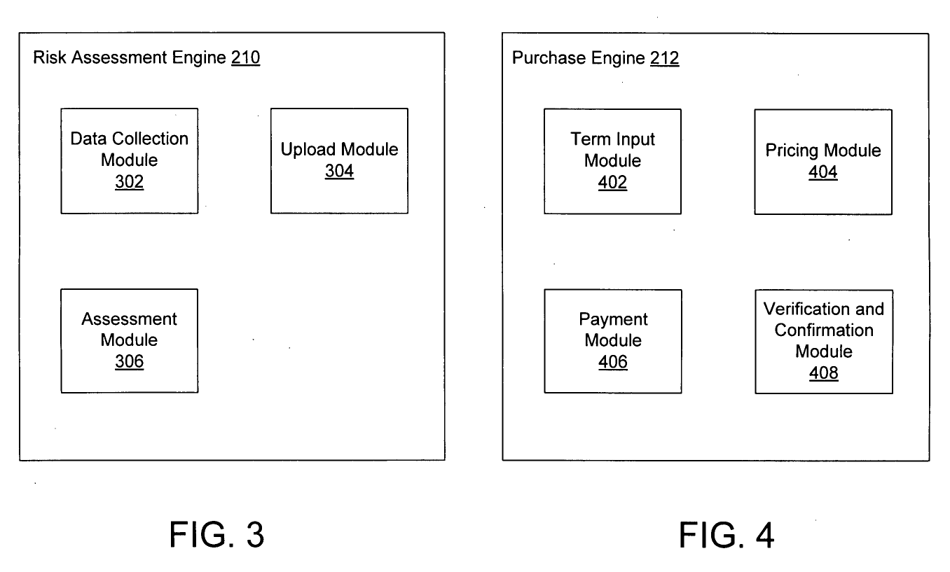

The exemplary risk assessment engine 210 is configured to analyze purchaser financial data to determine sensitivity of the purchaser's business to a risk, such as weather. More particularly, the risk assessment engine 210 provides guidance as to how certain types of weather conditions impact revenue for the business. It should be noted that the risk assessment engine 210 is an option in some embodiments. The risk assessment engine 210 is discussed in more detail in connection with FIG. 3.

The purchase engine 212 is configured to determine, in an automated manner, a price for an OTC derivative. Furthermore, the purchase engine 212 may complete a transaction for the sale of the OTC derivative. The purchase engine 212 will be discussed in more detail in connection with FIG. 4.

The weather data collection module 214 is configured to obtain weather information from a plurality of weather stations. The weather information is then used to determine if terms of an OTC derivative are met which require a payout or settlement on the OTC derivative. In exemplary embodiments, the weather stations utilized are owned and run by the National Weather Service. Data feeds from the National Weather Service are provided to a third party, which cleans and audits the information. Thus, an independent third party audits the data for accuracy. The weather information may be accessed in real-time. Alternatively, the weather information may be stored in the historical weather database 218 for later review.

The weather forecast database 220 is configured to store weather forecasts. In exemplary embodiments, the purchase engine 212 models or simulates weather behavior in order to determine future risks. The results of the modeling is stored in the weather forecast database 220

In exemplary embodiments, the payout engine 222 is configured to determine, in an automated manner, whether the OTC derivative requires settlement (i.e., payout). If settlement is required, then the payout engine 222 will process the payout (e.g., credit the purchaser's account). In general, the payout engine 222 reviews data received at predetermined times to determine if any triggers, as defined by the derivative terms, have been exceeded. For example, in the weather derivative embodiment, weather data may be received daily via the weather data collection module 214. The weather data is then used by the payout engine 222 to determine if various triggers, as defined by the terms of the OTC derivative, have been reached. If a payout trigger is exceeded, then settlement is required.

Referring now to FIG. 3, an exemplary risk assessment engine 210 is shown. The risk assessment engine 210 comprises a data collection module 302, an upload module 304, and an assessment module 306. Alternative embodiments may comprise more, less, or functionally equivalent components and still be within the scope of embodiments of the present invention.

The data collection module 304 is configured to obtain purchaser financial data that is non-uploadable. The purchaser financial data is then utilized by the assessment module 306 to perform an assessment of a business' weather risks as will discussed below.

The upload module 304 is configured to obtain uploadable purchaser revenue-related data. In one embodiment, the upload module 304 allows a purchaser 106 to upload to the derivative seller system 200. In alternative embodiments, other forms of financial reports may be uploaded to the derivative seller system 200. In some embodiments, cost-related reports or cost and revenue related reports may be uploaded to the upload module 304 to determine exposure of revenue, costs, and/or profits to weather related events.

The risk assessment module 306 takes the received purchaser revenue-related data and determines the weather risks for the purchaser 106. The purchaser 106 may utilize the results of the assessment to determine a best type of OTC derivative to purchase based on the weather risk(s) their business is most susceptible to. In an embodiment utilizing uploaded purchaser revenue-related data, the revenue and corresponding dates that the revenue is generated are correlated to historical weather (e.g., from the historical weather database 218) for each day. As such, the assessment module 306 correlates the business financial data with weather patterns to determine what the purchaser business is most sensitive to and their relationship to temperature and precipitation. This type of risk assessment is a customized risk assessment.

In an embodiment not utilizing uploaded purchaser financial data, the data collection module 302 requests the purchaser 106 to enter revenue-related information in order to perform a simplified risk assessment. The entered revenue- related information comprises purchaser location, average annual revenue, and an indication as to whether weekends are included in the calculation of the annual revenue. The purchaser 106 is then provided a series of sliders through which the purchaser 106 can indicate (e.g., by sliding along a scale) seasonality of their business (e.g., weekly, monthly, or quarterly). The purchaser 106 may, optionally, be provide a series of sliders or a graph which allow the purchaser 106 to estimate how their business does based on temperature, precipitation, snowfall, etc.

Based on all the entered revenue-related data, an artificial revenue based on weather is generated. In exemplary embodiments, the assessment module 306 accesses historical weather data for a particular amount of time (e.g., 10 years). Revenue is then recreated given the entered revenue-related data. The artificial revenue is generated based on the recreated revenue over the particular amount of time based on the historical weather data. For example, the assessment module 306 may determine that on average the business is going plus or minus a certain dollar amount per year based on temperature. In another example, the risk assessment module 306 may determine that a business seems to lose the most money when a certain temperature is exceeded or rainfall exceeds a given number of days. Based on the analysis, an assessment of the business' risks in relation to certain weather conditions is determined.

FIG. 4 is a block diagram of the exemplary purchase engine 212. The purchase engine 212 comprises a term input module 402, a pricing module 404, a payment module 406, and a verification and confirmation module 408. Alternative embodiments may comprise more, less, or functionally equivalent components and still be within the scope of embodiments of the present invention.

The term input module 402 is configured to obtain derivative terms utilized to price the OTC derivative. In the weather derivative embodiment, derivative terms may comprise a start and end date (or term) of the OTC derivative, a location of a weather station from which weather measurements are derived, a scheme for generating a weather index based on the weather measurements over the term, and a payout mechanism utilizing the weather index. In alternative embodiments, different derivative terms for other types of derivatives may be utilized. For example, an equity derivative may comprise a term defining an underlying asset (e.g., stock or option), for which a market price is measured to determine a payout at some specific date in the future. A more detailed discussion of customizable terms of the OTC derivative is provided in U.S. patent application Ser. No. ______ entitled “System and Method for Creating Customized Derivatives,” which is incorporated by reference.

Based on the derivative term inputs, the pricing module 404 determines a price for the requested OTC derivative in an automated manner. In exemplary embodiments, the pricing module 404 will take into consideration factors such as expected net payout on the OTC derivative and a risk premium. The expected net payout may be based, at least in part, on historical data (e.g., historical weather data). The expected net payout may also be based on weather predictions (e.g., by modeling or simulating weather behavior and factoring in increased risk based on future uncertainty which may increase depending on how far in the future the weather derivative is expected to cover). These weather predictions may be stored in the weather forecast database 220. The risk premium is a function of a payout risk (i.e., calculated standard deviation of payout) and portfolio risk (i.e., incorporate risk of existing contracts and difference in the risk due to the present OTC derivative). The price quote is then presented to the purchaser 106.

If the purchaser 106 decides to purchase the OTC derivative, payment information is obtained and processed by the payment module 406. In some embodiments, payment information may have been previously provided and stored in the purchaser's account. In these embodiments, the payment information will be accessed and automatically processed. In other embodiments, the purchaser 106 provides the payment information at the time of purchase. For example, the purchaser 106 may provide a wire transfer, credit card charge authorization, an electronic fund transfer, or any other payment mechanism authorization.

The exemplary verification and confirmation module 408 verifies in an automated manner that payment is received and that all requirements have been complied with in order to complete the sales transaction. In some embodiments, an acknowledgement that the purchaser 106 is qualified to purchase the OTC derivative may be required or reviewed. This qualification process may occur prior to the receipt of payment information via the payment module 406.

A verification of acceptance of the ISDA Master Agreement is also performed by the verification and confirmation module 408. In some embodiments, an ISDA Master Agreement is referenced, which the purchaser 106 reviewed upon account set-up. In other embodiments, the ISDA Master Agreement is provided to the purchaser 106 for digital signature at the time of purchase. Upon completion of sale, a purchase confirmation is provided to the purchaser 106 by the verification and confirmation module 408.

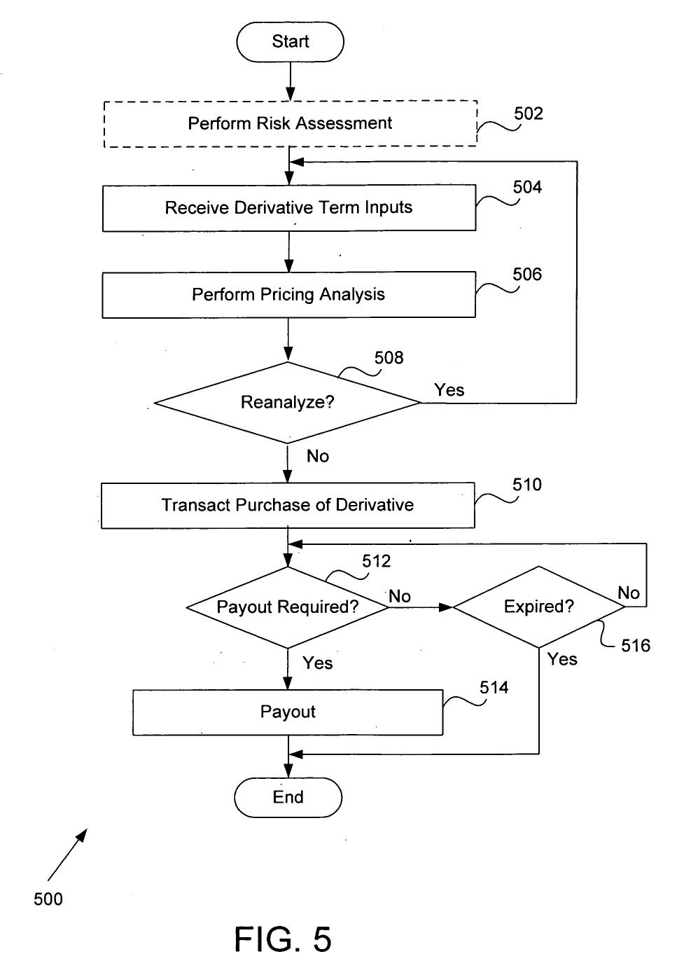

FIG. 5 illustrates a flowchart of an exemplary method for the automated pricing, purchase, and automated settlement of an OTC derivative. In optional step 502, a risk assessment is performed. The risk assessment may be performed for any purchaser 106 that is unsure as to how weather impacts their business. The risk assessment will provide the purchaser 106 with an assessment of the business' susceptibility to weather as well as the weather conditions that impact the business.

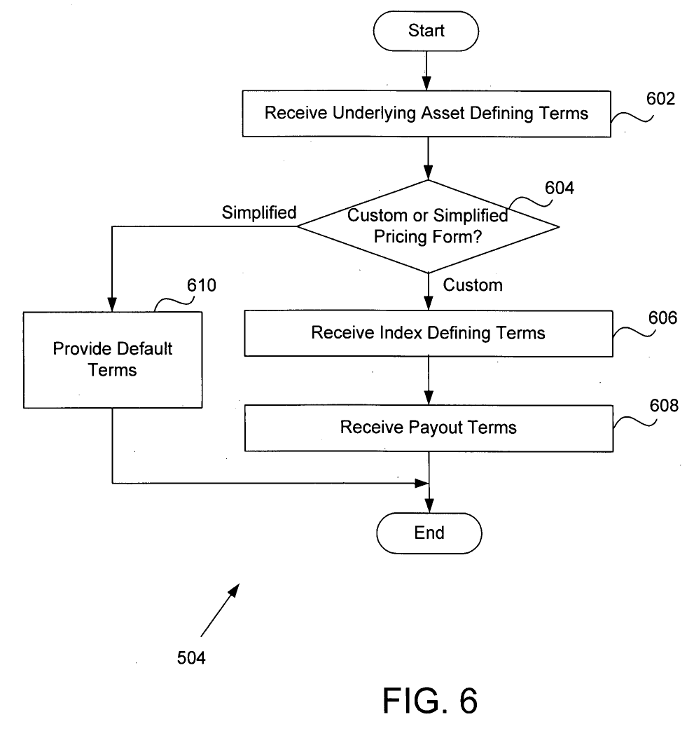

In step 504, derivative term inputs are received from the purchaser 106. In exemplary embodiments, the term input module 402 will provide a user interface through which the derivative terms are received from the purchaser 106. Step 504 will be discussed in more detail in connection with FIG. 6.

Based on all the derivative terms received in step 504, a pricing analysis is performed in step 506. In exemplary embodiments, the pricing analysis is performed by the pricing module 404 in an automated manner. In one embodiment, the price of the OTC derivative is based on expected payout and some risk premium. The risk premium is a function of a payout risk and portfolio risk. The payout risk comprises a calculated standard deviation of payout. The portfolio risk incorporates risk of existing derivatives for the derivative seller 102 and a difference in that risk due to the new OTC derivative currently being priced. As a result, a price for the requested OTC derivative is automatically generated and output to the purchaser 106. It should be noted that the price is non-negotiable in accordance with exemplary embodiments.

In step 508, the purchase engine 212 determines if the purchaser 106 requests a reanalysis of the OTC derivative. For example, the purchaser 106 may want to change one or more derivative terms in order to compare pricing for different OTC derivatives. If reanalysis is requested, the method returns to step 504.

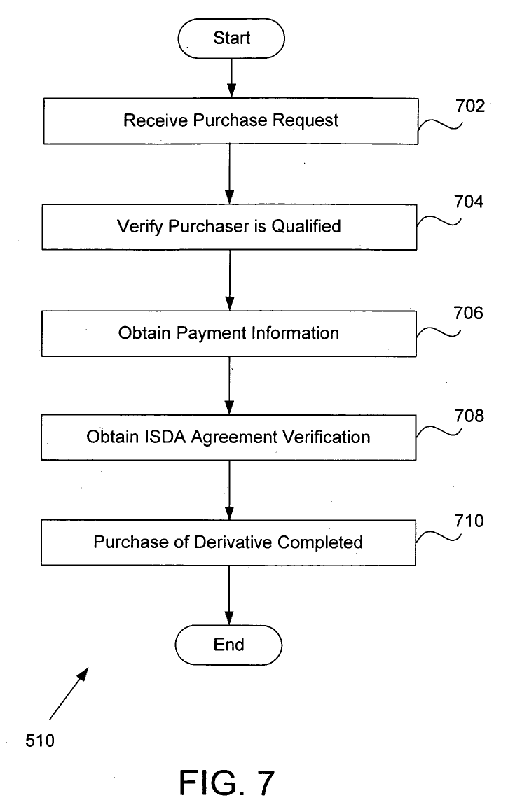

Should the purchaser 106 decide to purchase the OTC derivative at the quoted price, the purchase transaction is performed in step 510. Step 510 will be discussed in more detail in connection with FIG. 7.

In step 512, the payout engine 222 determines if a payout (i.e., settlement) on the OTC derivative is required. In exemplary embodiments, the payout engine 222 reviews data received at predetermined times to determine if any triggers, as defined by the derivative terms, have been met. For example, in the weather derivative embodiment, weather data may be received at a predetermined time (e.g., daily) by the weather data collection module 214. The weather data is then used by the payout engine 222 to determine if various triggers, as defined by the terms of the OTC derivative, have been reached.

If a payout trigger is exceeded, then settlement may be automatically performed by the payout engine 222 in step 514. In some embodiments, the payout engine 222 will provide a credit to the purchaser's account with the derivative seller 102. In other embodiments, funds may be transferred to an account at a financial institution designated by the purchaser. According to some embodiments, the payout may be made over a period of time, as defined by payout terms of the OTC derivative.

If the payout trigger is not met and payout is not required in step 512 based on the data received at the predetermined time, then a determination may be made in step 516 as to whether the OTC derivative is still active. If the OTC derivative, based on the derivative terms, has not expired, then the payout engine 222 will continue to monitor data as it is received to determine if settlement is required.

Referring now to FIG. 6, a flowchart of an exemplary method for receiving derivative term inputs (step 504) is shown. These derivative term inputs are received by the term input module 402, and utilized by the pricing module 404 to determine the price of the OTC derivative. The derivative terms inputs are also utilized to determine if settlement upon a purchased OTC derivative is required. In step 602, the term input module 402 receives the underlying asset defining terms for the OTC derivative. In the weather derivative embodiment, the asset defining terms may comprise a type of weather phenomenon measured, the weather station location where the measurements occur, and dates the measurements shall take place. In various embodiments, the purchaser 106 may manually enter the dates, select the dates from a graphical calendar, or use one or more pull-down menus to select the month, day, and year of the start and dates. In other embodiments, the purchaser 106 may enter a start date and select a derivative length (e.g., six months, one year, etc:).

The asset defining terms for the weather derivative may further comprise a weekday/weekend selection. In exemplary embodiments, the purchaser 106 has the option of pricing the OTC derivative based on weekdays only, weekends only, or full week (i.e., weekday and weekend) coverage. This option allows a purchase 106 that is weekday or weekend dependent business to limit their coverage to a portion of the week that is more important for their business. For example, an amusement park may be interested in an OTC derivative that only covers the weekend during non-summer months since the bulk of their business occurs on the weekends during these months, whereas a restaurant in a business park may be interested in an OTC derivative that only covers weekday since they have limited business on the weekends.

In various embodiments, the asset defining terms may also comprise location information. The location information input may comprise a selection of, for example, a weather station closest to the location of the purchaser. For example, the purchaser 106 may scroll through a pull-down menu of weather stations and select the closest one. Alternatively, the purchaser 106 may provide a zip code or a city and state of their business, and the term input module 402 will return a listing of one or more weather stations. In another alternative embodiment, the purchaser 106 may select a weather station from a digital map identifying weather stations with selectable markers.

In alternative embodiments, the underlying asset defining terms may vary based on the type of derivative being priced. For example, an equity derivative may comprise asset defining terms such as identification of the underlying equity's ticker and the expiration date of the derivative.

In exemplary embodiments of the present invention, the purchaser 106 customizes the OTC derivative. As such specific, customized terms for the purchaser 106 will be requested by the term input module 402 as will be discussed in connection with steps 606 and 608 below. However, in alternative embodiments, default terms may be provided to the purchaser. As such, in optional step 604, the purchase engine 212 determines if the purchaser 106 is utilizing the custom or simplified pricing form, which will determine what further derivative term inputs are needed from the purchaser 106. The custom pricing form will allow the purchaser 106 to enter index defining terms and payout terms. In contrast, the simplified pricing form will provide a default set of terms for index definition and payout terms based on simple inputs.

If the custom pricing form is used, further derivative terms are directly requested from the purchaser 106. In step 606, index defining terms (e.g., definition of ticks for a weather index) are requested and received from the purchaser. In the weather derivative example, the operation on the underlying weather measurements may be selected. For example, the purchaser 106 may desire to define the index as a sum of daily weather measurements above a daily threshold, made at the selected weather station.

The index defining terms may also comprise threshold terms to determine “daily values” that will determine the weather index. The threshold terms may comprise a threshold value and a threshold trigger. The threshold value may comprise any value. For example, the threshold value may be two inches of rain or a temperature of 65 degrees.

The threshold trigger may comprise a measurement above the threshold value (e.g., any day it rains over 2 inches), a measurement below a threshold value (e.g., any day the temperature is below 65 degrees), or a binary trigger (e.g., any day that it rains regardless of the amount of rain). Any condition which exceeds the threshold trigger will result in a “tick” value. Ticks may be based on daily values. For example, every measurement of rain above the threshold value zero (i.e., the threshold trigger) in a day results in a weather parameter tick. Thus, one inch is equal to one tick, while 0.45 inches is equal to 0.45 ticks. A similar weather parameter tick mechanism applies to temperature. For example, one degree over a threshold temperature results in one tick. In some embodiments, daily ticks are used instead of the weather parameter tick. For example, any day that is rains for more than 2 inches results in a tick value for that day.

In step 608, the term input module 402 receives payout terms. The payout terms may comprise a payout amount, a payout trigger type, and a payout trigger. The payout amount indicates an amount of money that the purchaser 106 will receive if the payout trigger is reached or exceeded. The payout trigger is a condition that must occur or be exceeded to cause a payout on the OTC derivative. The payout trigger is correlated to the tick values. In exemplary embodiments, the payout trigger may be based on the payout trigger type. The payout trigger type may be based on the occurrence of any single tick (e.g., payout any day that it rains more than 5 inches), per tick of a threshold trigger (e.g., pay $100 per inch of rain), or a sum of all ticks (e.g., payout if it rains for more than 50 days during the term of the OTC derivative). In further embodiments, the payout terms may comprise a payout timeline (e.g., for payouts over a period of time).

If the simplified pricing form is selected, default index and payout terms are provided to the purchaser 106 in step 610 based on, for example, business specific inputs as provided by the purchaser 106. Alternative embodiments may require other simple inputs from the purchaser 106 to determine the default terms. The default terms may be based on derivative terms that are most popular or most requested by businesses having similar revenue, location, and/or in the same industry. In some embodiments, a plurality of default terms may be provided to the purchaser 106, from which a selection may be made. For example, a set of default terms may be provided to the purchase 106 via one or more fields, each having a pull down menu. If the purchaser 106 desires to change the default term, the purchaser 106 may activate the pull down menu and select a different default term. If the purchaser 106 agrees with using the default terms, then the purchaser 106 may just request a price quote via activating a corresponding button. In other embodiments, the default terms may be directly edited (e.g., the purchaser 106 enters a different value in a field where the fixed input is presented) by the purchaser 106.

Referring now to FIG. 7, a flowchart 700 of an exemplary method for transacting the purchase of the OTC derivative is shown. Once the purchaser 106 receives the price quote for the OTC derivative based on the derivative terms provided by the purchaser 106, the purchaser 106 may purchase the OTC derivative directly on the same platform (i.e., the derivative seller system 200). In step 702, the purchase engine receives a purchase request.

Subsequently, the verification and confirmation module 408 verifies that the purchaser is qualified to purchase the OTC derivative in step 704. In exemplary embodiments, the verification and confirmation module 408 will review the purchaser's account to determine if the purchaser 106 has previously acknowledged their eligibility (e.g., business with more than five million in revenue or an individual with more than one million in revenue). Alternatively, the verification and confirmation module 408 may, at the time of the purchase, request the acknowledgment of eligibility from the purchaser 106.

In step 706, payment information is obtained. In some embodiments, the payment module 406 will access the payment information stored in the purchaser's account. In other embodiments, the purchaser 106 will be requested, at the time of the purchase, to provide payment information.

An ISDA Master Agreement verification is obtained by the verification and confirmation module 408 in step 708. In some embodiments, the purchaser 106 is requested to sign a digital ISDA Master Agreement at the time of the purchase. In other embodiments, an ISDA Master Agreement stored in the purchaser's account is referenced.

Upon receipt of the various verifications and approval of the payment, the purchase of the OTC derivative is completed in step 710. In exemplary embodiments, a confirmation is sent to the purchaser 106 by the verification and confirmation module 408. The confirmation may be sent via e-mail, fax, mail, provided on a page of the website, or any combination of these methods.

In an embodiment where the purchaser 106 has not established an account with the derivative seller 102, the purchaser 106 may be required or given an option to set up an account. This may occur either prior to step 704 or at the conclusion of the purchase (after step 710). If the account set-up occurs after step 710, the acknowledgments and payment data may automatically be used to establish the account.

It should be noted that the method of FIG. 7 is exemplary. In alternative embodiments, the steps may be practiced in a different order. For example, all verification (steps 704 and 708) may be performed before processing of the payment information (step 706) or be performed after the processing of the payment information.

The above-described functions and components can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

What is claimed is:

1. A method for selling and settling an over-the-counter (OTC) derivative on a single party platform, comprising:
receiving terms for the OTC derivative;
performing a pricing analysis based on the terms;
providing an automated price for the OTC derivative; and
receiving payment information from a purchaser of the OTC derivative.

2. The method of claim 1 wherein the OTC derivative comprises a weather derivative.

3. The method of claim 1 wherein the OTC derivative comprises an equity derivative.

4. The method of claim 1 further comprising verifying whether the purchaser is qualified to purchase the OTC derivative.

5. The method of claim 1 further comprising receiving a digital signature for an ISDA Master Agreement.

6. The method of claim 1 further comprising linking an agreement, based on the ISDA Master Agreement, to a purchase transaction.

7. The method of claim 1 further comprising associating an agreement, based on the ISDA Master Agreement, with an account of the purchaser.

8. The method of claim 1 further comprising automatically settling the OTC derivative upon an occurrence of a payout trigger.

9. The method of claim 8 further comprising making payments to the purchaser over a period of time as defined by the terms of the OTC derivative upon an occurrence of a payout trigger.

10. The method of claim 8 further comprising making an automated settlement payment to the purchaser of the OTC derivative.

11. The method of claim 1 wherein receiving terms for the OTC derivative comprises receive underlying asset defining terms.

12. The method of claim 1 wherein receiving terms for the OTC derivative comprises receiving index defining terms.

13. The method of claim 1 wherein receiving terms for the OTC derivative comprises receiving payout terms.

14. The method of claim 1 further comprising performing a risk assessment.

15. The method of claim 1 further comprising repeating the pricing analysis with one or more different terms.

16. The method of claim 1 wherein performing a pricing analysis comprises determining an expected payout and a risk premium.

17. The method of claim 16 wherein the determining the risk premium comprises determining a payout risk and a portfolio risk.

18. A system for selling and settling an over-the-counter (OTC) derivative on a single party platform, comprising
a term input module configured to obtain terms for the OTC derivative;
a pricing module configured to determine a price for the OTC derivative based on the terms; and
a payment module configured to obtaining payment information to transact the sale of the OTC derivative.

19. The system of claim 18 further comprising a verification and confirmation module configured to verify that the purchaser is qualified to purchase the OTC derivative.

20. The system of claim 18 further comprising a verification and confirmation module configured to associate an agreement, based on the ISDA Master Agreement to the sale of the OTC derivative.

21. The system of claim 18 further comprising a risk assessment module configured to assess risks for a purchaser of the OTC derivative.

22. The system of claim 18 further comprising a payout engine configured to determine, in an automated manner, if settlement on the OTC derivative is required and to settle the OTC derivative.

23. A machine readable medium having embodied thereon a program comprising instructions, the instructions providing a method for selling and settling an over-the-counter (OTC) derivative on a single party platform, the method comprising
receiving terms for the OTC derivative;
performing a pricing analysis based on the terms for the OTC derivative;
providing an automated price for the OTC derivative; and
receiving payment information from a purchaser of the OTC derivative.
